(19) United States
(12) Patent Application Publication
(10) Pub. No.: US 2023/0186079 A1
(43) Pub. Date: Jun. 15, 2023

(54) LEARNING AN OPTIMAL PRECODING POLICY FOR MULTI-ANTENNA COMMUNICATIONS

(71) Applicant: Telefonaktiebolaget LM Ericsson (publ), Stockholm (SE)

(72) Inventors: Heunchul Lee, Täby (SE); Maksym Girnyk, Solna (SE); Jaeseong Jeong, Solna (SE)

(21) Appl. No.: 17/924,125

(22) PCT Filed: May 11, 2020
(86) PCT No.: PCT/EP2020/062993

§ 371 Date: Nov. 9, 2022

(51) Int. Cl. G06N 3/08

(52) U.S. Cl. CPC G06N 3/08

(57) ABSTRACT

Systems and methods for learning and applying an optimal precoding policy for multi-antenna communications in a Multiple Input Multiple Output (MIMO) system are disclosed.

### TECHNICAL FIELD

The present disclosure relates to a multi-antenna or Multiple Input Multiple Output (MIMO) system and, in particular, to precoder selection for a MIMO system.

### BACKGROUND

The area of cellular communications is undergoing an explosive development, penetrating ever wider segments of society and industry. Next-generation wireless communication networks will be addressing a number of new use cases. Apart from expected enhancements in mobile broadband, this time driven by emerging extended reality (XR) applications, new services such as, e.g., ultra-reliable low-latency and massive machine-type communications pose a number of rather challenging requirements on future communication networks. These requirements include higher data rates, lower latency, higher energy efficiency, and lower operational and capital expenditures. Consequently, such networks are expected to be rather complex and difficult to model, analyze, and manage in traditional ways.

Multiple Input Multiple Output (MIMO) has been a key physical-layer technology in the Third Generation Partnership Project (3GPP) Fourth Generation (4G) Long Term Evolution (LTE) and Fifth Generation (5G) New Radio (NR) communication systems, and MIMO will remain a key technology in future wireless networks. The use of multiple antennas at both transmitter and receiver in wireless communication links provides a means of achieving higher data rate and lower Bit Error Rate (BER). The full potential of MIMO systems can be realized by utilizing Channel State Information (CSI) in the precoding design at the transmitter. LTE and NR systems support two precoding modes, namely codebook-based precoding and non-codebook-based precoding. In the codebook-based precoding mode, a pre-defined codebook is given by a finite set of precoders and shared between the transmitter and receiver. The receiver chooses the index of a best precoder in the codebook and feeds back the index to the transmitter. However, the precoding operation based on the pre-defined codebook will lead to performance loss. Meanwhile, the non-codebook-based precoding mode operates in a continuous space of possible precoders, trying to match the precoder to the actual channel realization. In this mode, the CSI is usually acquired from the channel reciprocity, and the precoder is computed based on the acquired CSI at the transmitter, while the receiver is not aware of the transmitter's precoder.

Orthogonal Frequency Division Multiplexing (OFDM) modulation has been widely applied in modern communication systems. The multicarrier technique divides the total available bandwidth into a number of equally spaced subcarriers. The properties of OFDM modulation turn a frequency-selective MIMO channel into a set of frequency-flat frequency-time Resource Elements (REs). An optimal precoding scheme would involve designing the best possible channel-dependent precoder on a per-RE basis. However, this approach is not practical due to issues with channel estimation and hardware implementation that arise on such a fine granularity. Instead, in a practical MIMO-OFDM system, a precoder is chosen on per-subband basis, achieving a tradeoff between performance and complexity. A practical subband-precoding solution is obtained based on a spatial channel covariance matrix averaged over the pilot signals in a given subband. Unfortunately, this solution is sub-optimal, and furthermore no truly optimal solution has been found for this setting to date.

Machine Learning (ML), as a sub-field of Artificial Intelligence (AI), is playing increasingly important roles in many applications ranging from small devices, such as smartphones and wearables, to more sophisticated intelligent systems such as self-driving cars, robots, and drones. Reinforcement Learning (RL) is a set of ML techniques that allow an agent to learn an optimal action policy through trial-and-error interactions with a challenging dynamic environment that returns the maximum reward [1]. These ML techniques are particularly relevant to the applications where mathematical modelling and efficient solutions are not available. RL algorithms can be classified into model-based and model-free methods, and the model-free methods can be further divided into value-based and policy-based. Model-based RL algorithms have access to a model of the environment or learn it. The environment model allows the RL agent to plan a policy by estimating the next state transitions and corresponding rewards. In comparison, model free RL algorithms require no knowledge of state transitions and reward dynamics. These RL algorithms directly learn a value function or optimal policy from interactions with complex real-world environments, without explicitly learning the underlying model of the environment.

Motivated by recent advances in deep-learning (DL) [2], Deep Reinforcement Learning (DRL) combines neural networks with a RL learning model to achieve fully automated learning of optimal action policies, which is proved in deep Q-network (DQN) algorithm [3] [4] with discrete action space and Deep Deterministic Policy-Gradient (DDPG) [5] with continuous action space.

### SUMMARY

In order address the gap between the unknown optimal solution for Multiple-Input Multiple-Output (MIMO) precoding on a per-resource-element basis and the conventional sub-optimal solution for MIMO precoding on a per-subband basis, a deep reinforcement learning-based precoding scheme is disclosed herein that can be used to learn an optimal precoding policy for very complex MIMO systems. In one embodiment, a method performed by an agent for training a first neural network that maps a MIMO channel state to a precoder in a continuous precoder space comprises initializing first neural network parameters, φ, of a first neural network, F_{φ}(H), that estimates a first precoding policy that maps a channel state, H, for a MIMO system to a precoder, w, in a continuous precoder space. The method further comprises initializing second neural network parameters, θ, of a second neural network, S_{θ}(H, w), that estimates a value function that maps the channel state, H, for the MIMO system and the precoder, w, in the continuous precoder space to a value, q, of the precoder, w, in the channel state H. The method further comprises initializing an initial channel state, H₀, for the MIMO system based on a channel model for the MIMO system or a channel measurement in the MIMO system. The method further comprises, for each time t in a set of times t=0 to t=T−1 where T is a predefined integer value that is greater than 1, performing a number of actions. These actions include choosing or obtaining a precoder, wₜ, for a channel state, Hₜₜ, that is to be executed or has been executed by a MIMO transmitter in the MIMO system, observing a parameter in the MIMO system as a result of execution of the precoder, wₜ, and computing a reward, rₜₜ, based on the parameter. The actions further include observing a channel state, Hₜ₊₁, for time t+1, updating the second neural network parameters, θ, of the second neural network, S_{θ}(H, w), based on an experience [Hₜₜ, wₜ, rₜₜ, Hₜ₊₁]. The actions further include computing a gradient, ∇_{φ}F_{φ}, which is a gradient of the first neural network, F_{φ}(H), with respect to the first neural network parameters, φ, and computing a gradient, ∇_{w}S_{θ}, which is a gradient of the second neural network, S_{θ}(H, w), with respect to the precoder, w. The actions further include updating the first neural network parameters, φ, of the first neural network, F_{φ}(H), based on the gradient, ∇_{φ}F_{φ}, and the gradient, ∇_{w}S_{θ}. In this manner, an optimal precoding policy for the MIMO system on a per-resource-element basis is learned without the need for impractically complex hardware.

In one embodiment, the method further comprises either providing the first neural network parameters, φ, of the first neural network, F_{φ}(H), to the MIMO system (100) to be used by the MIMO system (100) for precoder selection or utilizing the first neural network, F_{φ}(H), for precoder selection for the MIMO system (100) during an execution phase.

In one embodiment, updating the first neural network parameters, φ, of the first neural network, F_{φ}(H), based on the gradient, ∇_{φ}F_{φ}, and the gradient, ∇_{w}S_{θ}, comprises updating the first neural network parameters, φ, of the first neural network, F_{φ}(H), in accordance with a rule:

φ←φ+η∇_{φ},F_{φ},(H)∇_{w}S_{θ}(H,w)|_{H=H}_{ₜ}_{w=F}_{_{φ}}_{(w}_{ₜ}₎

where η is a predefined learning rate.

In one embodiment, updating the second neural network parameters, θ, of the second neural network, S_{θ}(h, w), based on the experience [Hₜ, wₜ, rₜ, Hₜ₊₁] comprises updating the second neural network parameters, θ, of the second neural network, S_{θ} (H, w), based on the experience [Hₜ, wₜ, rₜ, Hₜ₊₁] in accordance with a Q-learning scheme.

In one embodiment, the parameter observed in the MIMO system as a result of execution of the precoder, wₜ, is block error rate. In one embodiment, the parameter observed in the MIMO system as a result of execution of the precoder, wₜ, is throughput. I one embodiment, the parameter observed in the MIMO system as a result of execution of the precoder, wₜ, is channel capacity.

In one embodiment, choosing or obtaining (708; 908) the precoder, wₜ, for the channel state, Hₜ, comprises choosing (708) the precoder, wₜ, for the channel state, Hₜ, as:

wₜ=F_{φ}(Hₜₜ)+ [symbol] ,

where [symbol] is an exploration noise. In one embodiment, the method further comprises providing the precoder, wₜ, to the MIMO system for execution by the MIMO transmitter. In one embodiment, the exploration noise is a random noise in the continuous precoder space. In one embodiment, the step of initializing the initial channel state, H₀, and the steps of choosing or obtaining the precoder, wₜ, observing the parameter in the MIMO system, computing the reward, rₜ, observing the channel state, Hₜ₊₁, updating the second neural network parameters, θ, computing the gradient, ∇_{φ}F_{φ}, computing the gradient, ∇_{w}S_{θ}, and updating the first neural network parameters, φ, for each time t in the set of times t=0 to t=T−1 are repeated for two or more episodes, and a variance of the exploration noise varies over the two or more episodes. In one embodiment, the variance of the exploration noise gets smaller over the two or more episodes.

In one embodiment, choosing or obtaining the precoder, wₜ, for the channel state, Hₜ, comprises choosing the precoder, wₜ, for the channel state, Hₜ, as:

wₜ= [symbol] (Hₜₜ),

where [symbol] corresponds to the first neural network, F_{φ}(H), but where an exploration noise is added to the first neural network parameters, φ. In one embodiment, the method further comprises providing the precoder, wₜ, to the MIMO system for execution by the MIMO transmitter. In one embodiment, the exploration noise is a random noise in a parameter space of the first neural network, F_{φ}(H). In one embodiment, the step of initializing the initial channel state, H₀, and the steps of choosing or obtaining the precoder, wₜ, observing the parameter in the MIMO system, computing the reward, rₜ, observing the channel state, Hₜ₊₁, updating the second neural network parameters, θ, computing the gradient, computing the gradient, ∇_{w} S_{θ}, and updating the first neural network parameters, φ, for each time t in the set of times t=0 to t=T−1 are repeated for two or more episodes, and a variance of the exploration noise varies over two or more episodes. In one embodiment, the variance of the exploration noise gets smaller over the two or more episodes.

In one embodiment, choosing or obtaining the precoder, wₜ, for the channel state, Hₜ, comprises obtaining the precoder, wₜ, for the channel state, Hₜ, from the MIMO system. In one embodiment, the precoder, wₜ, is a precoder, wₜ, selected in accordance with a conventional precoder selection scheme.

In one embodiment, the channel state, H, is a MIMO channel matrix with size nᵣ×nₜ. In one embodiment, the channel matrix is scaled by a phase of an element of the MIMO channel matrix. In one embodiment, the element of the MIMO channel matrix is an element that corresponds to a first transmit antenna of the MIMO transmitter and a first receive antenna of a respective MIMO receiver.

In one embodiment, the channel state, H, is a MIMO channel matrix with size nᵣ x nₜ that is scaled by a Frobenius norm of the MIMO channel matrix.

In one embodiment, the precoder, w, is processed to provide a precoder vector or matrix having a unit Frobenius norm.

In one embodiment, the precoder, w, is processed to provide a precoder vector or matrix whose elements have unit amplitude.

In one embodiment, the precoder, w, is processed to provide a precoder matrix whose row vectors have a unit norm.

In one embodiment, the first neural network, F_{φ}(H), and the second neural network, S_{θ}(H, w), are trained under a channel model that provides a channel matrix with size nᵣ×nₜ whose elements are independent and identically distributed zero-mean complex circularly-symmetric Gaussian random variables with unit-variance.

Corresponding embodiments of a processing node that implements an agent for training a first neural network that maps a MIMO channel state to a precoder in a continuous precoder space are also disclosed. In one embodiment, the processing node is adapted to initialize first neural network parameters, φ, of a first neural network, F_{φ}(H), that estimates a first precoding policy that maps a channel state, H, for a MIMO system to a precoder, w, in a continuous precoder space. The processing node is further adapted to initialize second neural network parameters, θ, of a second neural network, S_{θ}(H, w), that estimates a value function that maps the channel state, H, for the MIMO system and the precoder, w, in the continuous precoder space to a value, q, of the precoder, w, in the channel state H. The processing node is further adapted to initialize an initial channel state, H₀, for the MIMO system based on a channel model for the MIMO system or a channel measurement in the MIMO system. The processing node is further adapted to, for each time t in a set of times t=0 to t=T−1 where T is a predefined integer value that is greater than 1, perform a number of actions. These actions include choosing or obtaining a precoder, wₜ, for a channel state, Hₜ, that is to be executed or has been executed by a MIMO transmitter in the MIMO system, observing a parameter in the MIMO system as a result of execution of the precoder, wₜ, and computing a reward, rₜ, based on the parameter. The actions further include observing a channel state, Hₜ₊₁, for time t+1, updating the second neural network parameters, θ, of the second neural network, S_{θ}(H, w), based on an experience [Hₜ, wₜ, rₜ, Hₜ₊₁]. The actions further include computing a gradient, ∇_{φ}F_{φ}, which is a gradient of the first neural network, F_{φ}(H), with respect to the first neural network parameters, φ, and computing a gradient, ∇_{w}S_{θ}, which is a gradient of the second neural network, S_{θ}(H, w), with respect to the precoder, w. The actions further include updating the first neural network parameters, φ, of the first neural network, Fₚ(H), based on the gradient, ∇_{φ}F_{φ}, and the gradient, ∇_{w}S_{θ}. In this manner, an optimal precoding policy for the MIMO system is learned.

In one embodiment, a processing node that implements an agent for training a first neural network that maps a MIMO channel state to a precoder in a continuous precoder space comprises processing circuitry configured to cause the processing node to initialize first neural network parameters, φ, of a first neural network, F_{φ}(H), that estimates a first precoding policy that maps a channel state, H, for a MIMO system to a precoder, w, in a continuous precoder space. The processing circuitry is further configured to cause the processing node to initialize second neural network parameters, θ, of a second neural network, S_{θ}(H, w), that estimates a value function that maps the channel state, H, for the MIMO system and the precoder, w, in the continuous precoder space to a value, q, of the precoder, w, in the channel state H. The processing circuitry is further configured to cause the processing node to initialize an initial channel state, H₀, for the MIMO system based on a channel model for the MIMO system or a channel measurement in the MIMO system. The processing circuitry is further configured to cause the processing node to, for each time t in a set of times t=0 to t=T−1 where T is a predefined integer value that is greater than 1, perform a number of actions. These actions include choosing or obtaining a precoder, wₜ, for a channel state, Hₜ, that is to be executed or has been executed by a MIMO transmitter in the MIMO system, observing a parameter in the MIMO system as a result of execution of the precoder, wₜ, and computing a reward, rₜ, based on the parameter. The actions further include observing a channel state, Hₜ₊₁, for time t+1, updating the second neural network parameters, θ, of the second neural network, S_{θ}(H, w), based on an experience [Hₜ, wₜ, rₜ, Hₜ₊₁]. The actions further include computing a gradient, ∇_{φ}F_{φ}, which is a gradient of the first neural network, F_{φ}(H), with respect to the first neural network parameters, φ, and computing a gradient, ∇_{w}S_{θ}, which is a gradient of the second neural network, S_{θ}(H, w), with respect to the precoder, w. The actions further include updating the first neural network parameters, φ, of the first neural network, F_{φ}(H), based on the gradient, ∇_{φ}F_{φ}, and the gradient, ∇_{w}S_{θ}. In this manner, an optimal precoding policy for the MIMO system is learned.

Embodiments of a method for precoder selection and application for a MIMO system are also disclosed. In one embodiment, the method comprises selecting a precoder, w, for a MIMO transmitter of the MIMO system using a first neural network, F_{φ}(H), that estimates a first precoding policy that maps a channel state, H, for the MIMO system to the precoder, w, in a continuous precoder space. The method further comprises applying the selected precoder, w, in the MIMO transmitter.

In one embodiment, the method further comprises training the first neural network, F_{φ}(H), based on a neural network parameter update rule:

φ←φ+η∇_{φ},F_{φ},(H)∇_{w}S_{θ}(H,w)|_{H=H}_{ₜ}_{w=F}_{_{φ}}_{(w}_{ₜ}₎

where:
φ is a first set of neural network parameters of the first neural network, F_{φ}(H);
η is a predefined learning rate;
∇_{φ}F_{φ} is a gradient of the first neural network, F_{φ}(H), with respect to the first set of neural network parameters, φ;
∇_{w}S_{θ} is a gradient of a second neural network, S_{θ}(H, w), with respect to the precoder, w, wherein the second neural network, S_{θ}(H, w), estimates a value function that maps the channel state, H, for the MIMO system and the precoder, w, to a value, q, of the precoder, w, in the channel state, H; and
θ is a second set of neural network parameters of the second neural network, S_{θ}(H, w).

In one embodiment, the method further comprises, while training the first neural network, F_{φ}(H), using a fallback precoder selection scheme for selection of the precoder, w, for the MIMO transmitter of the MIMO system until a predefined or preconfigured performance criterion is met for the first neural network, F_{φ}(H).

Corresponding embodiments of a processing node for precoder selection and application for a MIMO system are also disclosed. In one embodiment, the processing node is adapted to select a precoder, w, for a MIMO transmitter of the MIMO system using a first neural network, F_{φ}(H), that estimates a first precoding policy that maps a channel state, H, for the MIMO system to the precoder, w, in a continuous precoder space. The processing node is further adapted to apply the selected precoder, w, in the MIMO transmitter.

In one embodiment, a processing node for precoder selection and application for a MIMO system comprises processing circuitry configured to cause the processing node to select a precoder, w, for a MIMO transmitter of the MIMO system using a first neural network, F_{φ}(H), that estimates a first precoding policy that maps a channel state, H, for the MIMO system to the precoder, w, in a continuous precoder space. The processing circuitry is further configured to cause the processing to apply the selected precoder, w, in the MIMO transmitter.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a learning agent that operates to learn an optimal precoder policy for a Multiple Input Multiple Output (MIMO) Orthogonal Frequency Division Multiplexing (OFDM) system in accordance with an embodiment of the present disclosure;

FIG. 2 illustrates one example of a MIMO system for which embodiments of the present disclosure may be provided;

FIG. 3 illustrates the learning agent of FIG. 1 in which the learning agent includes two neural networks, namely, a first neural network, denoted by F_{φ}, that estimates a corresponding set of neural network parameters (φ) that estimate an optimal precoding policy that maps a MIMO channel state (H) to a precoder w in a continuous precoder space and a second network, denoted by S_{θ}, that is used for training the first neural network in accordance with an embodiment of the present disclosure;

FIG. 4 illustrates training of the first neural network, denoted by F_{φ}, based on a gradient (∇_{φ}F_{φ}) of F_{φ} with respect to φ and a gradient (∇_{w} S_{θ}) of S_{θ} with respect to the chosen precoder w, in accordance with an embodiment of the present disclosure;

FIG. 5 illustrates one example embodiment in which the learning agent takes an action (i.e., chooses a precoder wₜ) by perturbating a precoder provided by the first neural network F_{φ};

FIG. 6 is an illustration of one training iteration of the learning agent in accordance with one embodiment of the present disclosure;

FIG. 7 is a flow chart that illustrates the operation of the learning agent during a training phase in accordance with one embodiment of the present disclosure;

FIG. 8 is an illustration of one training iteration of the learning agent in accordance with another embodiment of the present disclosure;

FIG. 9 is a flow chart that illustrates the operation of the learning agent during a training phase in accordance with another embodiment of the present disclosure;

FIG. 10 is a flow chart that illustrates the operation of the system including the learning agent and MIMO system in accordance with another embodiment of the present disclosure; and

FIGS. 11 through 13 are schematic block diagrams of a processing node that may implement the learning agent in accordance with embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

To address the gap between the unknown optimal solution for Multiple-Input Multiple-Output (MIMO) precoding on a per-RE basis and the conventional sub-optimal solution for MIMO precoding on a per-subband basis, a deep reinforcement learning-based precoding scheme is disclosed herein that can be used to learn an optimal precoding policy for very complex MIMO systems. As described herein, a Reinforcement Learning (RL) agent learns an optimal precoding policy in continuous precoder (i.e., action) space from experience data in a MIMO system. The RL agent interacts with an environment of the MIMO system and channel in an experience sequence of given channel states, precoders taken, and performance parameters (e.g., Block Error Rate (BER), throughput, or channel capacity). The goal of the RL agent is to learn a precoder policy that optimizes the performance parameter (e.g., minimizes BER, maximizes throughput, or maximizes channel capacity). To this end, in one embodiment, the MIMO precoding problem for a single-user (SU) MIMO system is modeled as a contextual-bandit problem in which the RL agent sequentially selects the precoders to serve the environment of MIMO system from a continuous precoder space based on a precoder selection policy and contextual information about the environment conditions, while simultaneously adapting the precoder selection policy based on a reward feedback (e.g., BER, throughput, or channel capacity) from the environment to maximize a numerical reward signal.

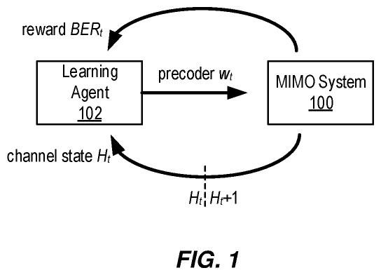

Now, a more detailed description of embodiments of the present disclosure will be provided. As illustrated in FIG. 1, without loss of generality, a precoding problem for a SU-MIMO system 100 is considered in which a learning agent 102 sequentially chooses precoders (wₜ) to serve the environment of the MIMO system 100 based on a precoder policy and conditions in the environment (i.e., the MIMO channel state or MIMO channel matrix Hₜ and Hₜ₊₁), while simultaneously adapting the precoder policy based on a reward feedback (e.g., BERₜ) from the environment to maximize a numerical reward signal (rₜ).

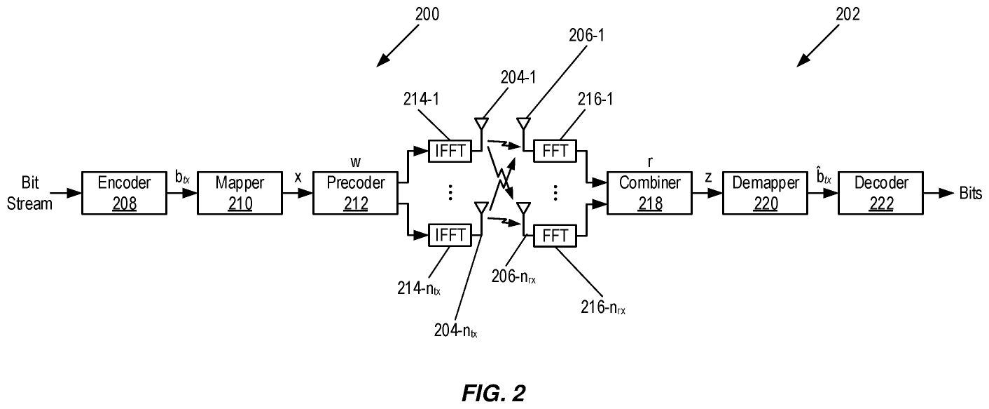

Before describing the details of the learning agent 102, a description of the SU-MIMO system 100 is beneficial. In this regard, FIG. 2 illustrates one example of the SU-MIMO system 100. The SU-MIMO system 100 is more specifically a MIMO-OFDM system including a transmitter 200 and a receiver 202. The transmitter 200 is equipped with nₜₓ transmit antenna 204-1 through 204-nₜₓ. The receiver 202 is equipped with nᵣₓ receive antennas 206-1 through 206-nᵣₓ. To exploit the spatial diversity available in MIMO systems, a precoding vector w ∈ [symbol] ^{ntx×1} is applied at the transmitter 200 and a combining vector r ∈ [symbol] ^{ntx×1} is applied at the receiver 202. At the transmitter 200, an encoder 208 encodes one transport bit stream into a bit block bₜₓ which is then symbol-mapped to modem symbols x by a mapper 210. Typical modem constellations used are M Quadrature Amplitude Modulation (M-QAM), which consists of a set of M constellation points. Then, a precoder 212 precodes the data symbols x by the precoding vector w to form nₜₓ data substreams. Finally, the streams are processed via respective Inverse Fast Fourier Transform (IFFTs) 214-1 through 214-nₜₓ to provide time-domain signals that are transmitted via the respective transmit antennas 204-1 through 204-nₜₓ. In a similar manner, at the receiver 202, signals received via the receive antennas 206-1 through 206-n are transformed to the frequency domain via respective Fast Fourier Transforms (FFTs) 216-1 through 216-n. A combiner 218 combines the resulting data streams by applying the combining vector r to provide a combined signal z. A demapper 220 performs system-demapping to provide a received bit block \hat{b}ᵣₓ which is then decoded by a decoder 222 to provide the received bit stream.

The set of data Resource Elements (REs) in a given subband is denoted herein by φ_{d} and a subband precoding application of a precoder w to the data REs i ∈ φ_{d} is considered. Further, xᵢ denotes the complex data symbol at the RE and yᵢ ∈ [symbol] ^{ntx×1} denotes the complex received signal vector at the RE. Then, the received signal at the RE i can be written as:

yᵢ=Hᵢwxᵢ+nᵢ, Equation 1

where Hᵢ ∈ [symbol] ^{n rx×n tx} represents the MIMO channel matrix between the transmit antenna 204-1 through 204-nₜₓ and the receive antennas 206-1 through 206-nᵣₓ at the RE i, and nᵢ, ∈ [symbol] ^{n rx×1} is an additive white Gaussian noise (AWGN) vector whose elements are i.i.d. complex-valued Gaussians with zero mean and variance σₙ². Without loss of generality, it is assumed that the data symbol xᵢ and the precoding vector w are normalized so that ∈[|xᵢ|²]= and ∥w∥²=1, where |·|denotes the absolute value of a complex value and ∥·∥denotes the 2-norm of a vector. Under these assumptions, the SNR is given by 1/σₙ².

At the receiver 202, the transmitted data symbol xᵢ can be recovered by combining the received symbols yᵢ by the unit-norm vector rᵢ (i.e., ∥rᵢ∥²=1), which yields the estimated complex symbol zᵢ as:

zᵢ=rᵢ⁺yᵢ=rᵢ⁺Hᵢwxᵢ+rᵢ⁺nᵢ, Equation 2

where (·)⁺ denotes the complex conjugate of a vector or matrix.

Note that rᵢ⁺Hᵢw in Equation (2) corresponds to the effective channel gain. It is assumed that a Maximal Ratio Combiner (MRC) is used at the receiver 202 (i.e., the combiner 218 is a MRC), which is optimal in the sense of output Signal to Noise Ratio (SNR) maximization when the noise is white.

As mentioned above, the optimal precoding solution is given by channel-dependent precoder on a per-RE basis. In other words, an optimal precoder wᵢ is chosen that maximizes the effective channel gain rᵢ⁺Hᵢwᵢ on a per-RB basis. However, in practical MIMO-OFDM systems, a precoder is chosen on per-subband basis, achieving a tradeoff between performance and complexity. A practical subband-precoding solution is obtained based on a spatial channel covariance matrix averaged over the pilot signals in a given subband. The set of pilot REs in a given subband is denoted by φₚ. The channel covariance matrix is given by:

$${R}_{hh} = \frac{1}{\vert {Φ}_{p} \vert} {\sum }_{j ∈ {Φ}_{p}} {H}_{j}^{†} {H}_{j} . \qquad Equation 3$$

Unfortunately, the conventional solution based on this covariance matrix is sub-optimal, and furthermore no truly optimal solution has been found for this setting to date.

In what follows, instead of approximating an optimal precoder based on the spatial channel covariance matrix, a learning scheme is described in which the learning agent 102 learns an optimal precoding policy directly from interactions with the complex real-world MIMO environment.

The learning agent 102 learns a precoding policy that optimizes a performance parameter through an experience sequence of given channel matrices, the precoders taken, and the values of the performance parameter achieved. In the remaining description, the performance parameter is BER. However, the performance parameter is not limited thereto. Other examples of the performance parameter are throughput and channel capacity.

Returning to FIG. 1, FIG. 1 illustrates a learning procedure where the learning agent 102 observes the MIMO channel state Hₜ of the MIMO system 100 and chooses a precoder wₑ to serve the environment. After each time step t, the learning agent 102 receives a feedback of BER performance BERₜ in return for the action taken (i.e., the execution of the chosen precoder wₑ). Over the times t=0,1, . . . , T−1, the learning agent 102 learns about how the channel states Hₜ and precoders wₑ relate to each other so that the learning agent 102 can predict the best precoder by observing the new MIMO channel in the next steps. Note that while the environmental state can be any environmental information that can help the learning agent 102 learn the optimal precoder policy, the example embodiments described herein the environmental state is represented by channel matrices on the pilot REs in a given subband. Thus, the MIMO channel state Hₜ can be defined by a set of vectorized channel matrices as follows:

H_{t ={[}vec(Re[Hⱼ])^{T},vec(Im[Hⱼ])^{T}]^{T}}_{j∈φ}_{ₚ} Equation 4

where Re [·] and Im[·] represent the real and imaginary parts of the complex valued MIMO channel matrix. Note that, regarding notation, Hⱼ is used herein to denote the channel matrix at RE j or i, whereas Hₜ is used herein to denote the environmental state at time t given by a single channel matrix Hⱼ or a set of channel matrices Hⱼ in pilot REs j at the time t.

Note that, in one embodiment, the ambiguity in phase information of the channel matrix H is removed. For instance, the channel matrix H with size nᵣ×nₜ can be scaled by the phase of element corresponding to the first transmit and first receive antenna, denoted by H(1,1), i.e.,

$$H ← \frac{H}{H ( 1 , 1 )} .$$

In addition, in one embodiment, the ambiguity in amplitude information of the channel matrix H is removed. For instance, the channel matrix H with size nᵣ×nₜ can be scaled by its Frobenius norm, denoted by ∥H∥_{F}, i.e.,

$$H ← \frac{H}{{‖ H ‖}_{F}} .$$

The learning agent 102 chooses a precoder wₜ in the MIMO channel state Hₑ according to the precoder policy and the chosen precoder wₜ is applied to the MIMO system 100 to get an experimental BER performance as a feedback. In particular, in one example, the BER performance is calculated by comparing the transmit code block bₜₓ and the receive code block \hat{b}ₜₓ as they represent the action value of precoder wₜ over the MIMO channel state Hₑ without help of channel coding. The experimental BER is represented by:

BERₑₓₚ^{t}=BER(bₜₓ,\hat{b}ₜₓ|Hₜ,wₜ), Equation 5

One example of the reward function computed based on the feedback is reward function rₜ ∈ [−0.5, +0.5]:

rₜ=log₂(1−BERₑₓₚ^{t})+0.5, Equation 6

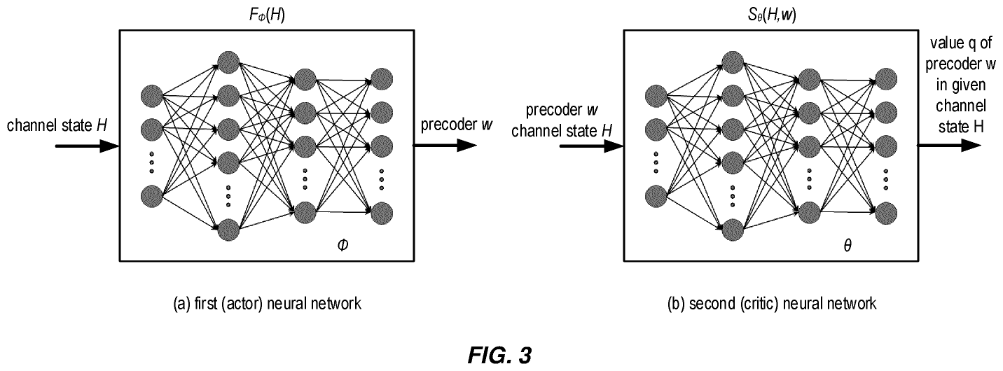

As illustrated in FIG. 3, the learning agent 102 is implemented by using two neural networks. A first neural network 300, denoted by F_{φ}, estimates the optimal precoding policy. In other words, the first neural network 300, denoted by F_{φ}, estimates a corresponding set of neural network parameters (φ) that estimate an optimal precoding policy that maps the MIMO channel state (Hₜ) at time t to a precoder wₜ in a continuous precoder space. Thus, the first neural network F_{φ}(H) takes the MIMO channel state H (i.e., the state) as input and provides a precoder w=F_{φ}(H) (i.e., the action). A second network, denoted by S_{θ}, estimates a precoder-value function. In other words, the second neural network 300, denoted by S_{θ}, estimates a corresponding set of neural network parameters (θ) that estimate a precoder-value policy that maps the MIMO channel state (Hₜ) and precoder wₜ at time t to a precoder-value qₜ in a non-continuous precoder space. Thus, the second neural network S_{θ}(s, a) takes not only the MIMO channel state H (i.e., the state) but also the precoder weight w (i.e., the action) as input and provides an output action value q=S_{θ}(H, w).

During the training phase, the first neural network F_{φ}(H) is used to select a precoder in such a way that different actions are explored for a same MIMO channel state H. Note that, in some embodiments, the output of the first neural network F_{φ}(H) is transformed in the form of a precoder vector or matrix for the MIMO transmission. For example, for digital precoding with unit-power constraint, the transformation includes a procedure for the precoder vector or matrix to have unit Frobenius norm. As another example, for analog precoding with constant modulus constraint, the transformation includes a procedure for each element of the precoder vector or matrix to have unit amplitude. In another example, the precoder w is processed to provide a precoder matrix whose row vectors have a unit norm.

At each time t, the precoder is executed by the MIMO system 100 in MIMO channel state Hₜ to provide a reward rₜ, generating the experience of [Hₜwₜ, rₜ]. Through the experiences [sₜ, aₜ, rₜ]=[Hₜ, wₜ, rₜ], the second neural network S_{θ} is trained by a Q-learning scheme to estimate the value of given MIMO channel state and chosen precoder. At the same time, the first neural network F_{φ} is trained by utilizing the gradient of the second neural network S_{θ} to update the neural network parameters φ of F_{φ} in the direction of performance gradient. More specifically, the first neural network F_{φ} is trained by the following parameter update rule:

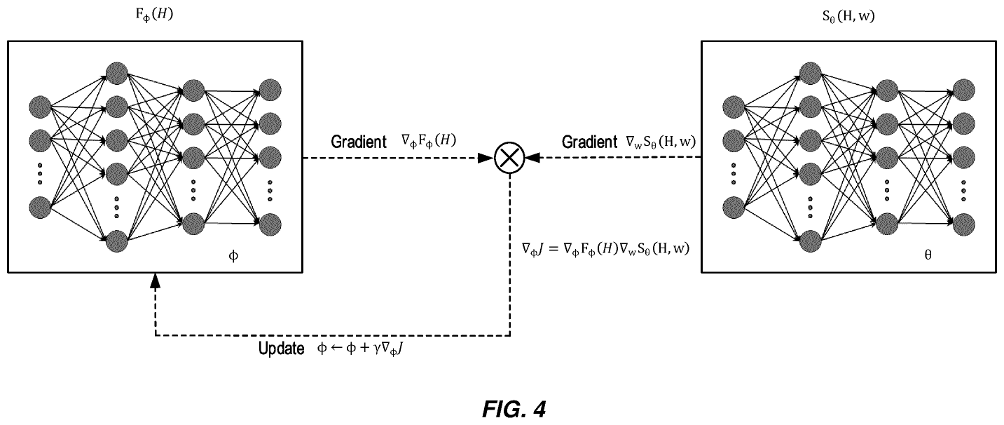

φ←φ+η∇_{φ}F_{φ}(H)∇_{w}S_{θ}(H,s)|_{H=H}_{ₜ}_{,w=F}_{_{φ}}_{(H}_{ₜ}₎, Equation 7

where η is a learning rate, ∇_{φ}F_{φ} is the gradient of F_{φ} with respect to φ, and ∇_{w}S_{θ} is the gradient of S_{θ} with respect to the chosen precoder w (i.e., the action). The operation of the learning agent 100 to train the first neural network F_{cp} using the above parameter update rule is illustrated in FIG. 4. Note that ∇_{φ}F_{φ},(H)∇_{w}S_{θ}(H, s) is denoted as ∇_{φ}J in FIG. 4.

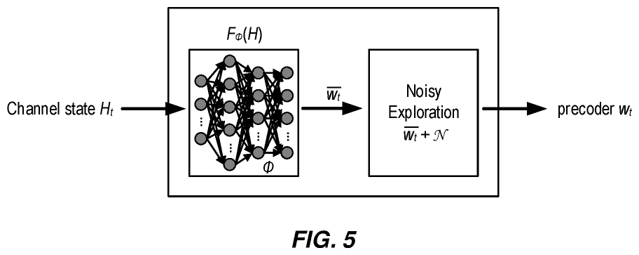

In one embodiment, during the training phase, the first neural network F_{φ}(H) is used to select a precoder in such a way that different precoders (i.e., different actions) are explored for the same MIMO channel state H. In this regard, FIG. 5 illustrates one example where the learning agent 100 takes an action (i.e., chooses a precoder wₜ) by perturbating a precoder provided by the first neural network F_{φ}. In this example, the deterministic precoder by F_{φ} is perturbated by adding noise vector [symbol] sampled from a Gaussian random process as follows:

wₜ=F_{φ}(Hₜ)+ [symbol] Equation 8

In other example, a random parameter noise is added to the parameters φ of the first neural network, i.e.,

wₜ= [symbol] (Hₜ) Equation 9

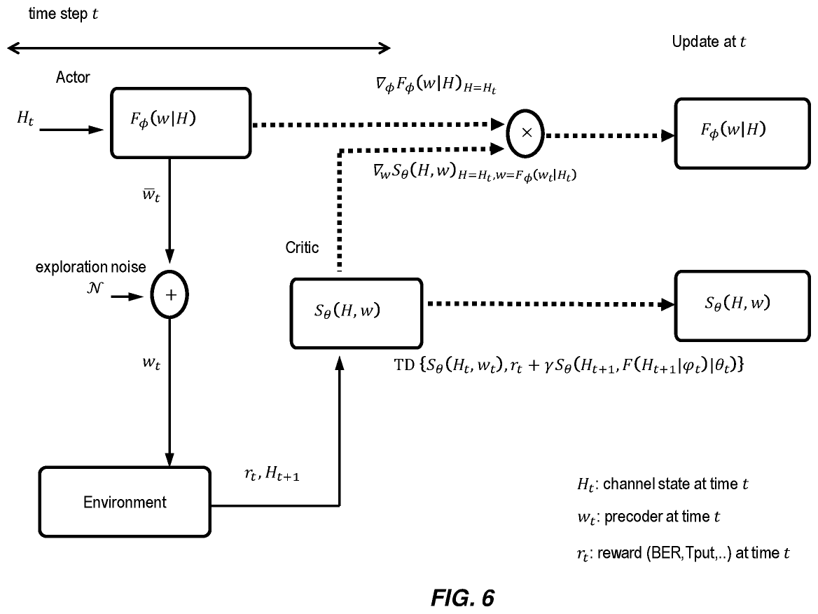

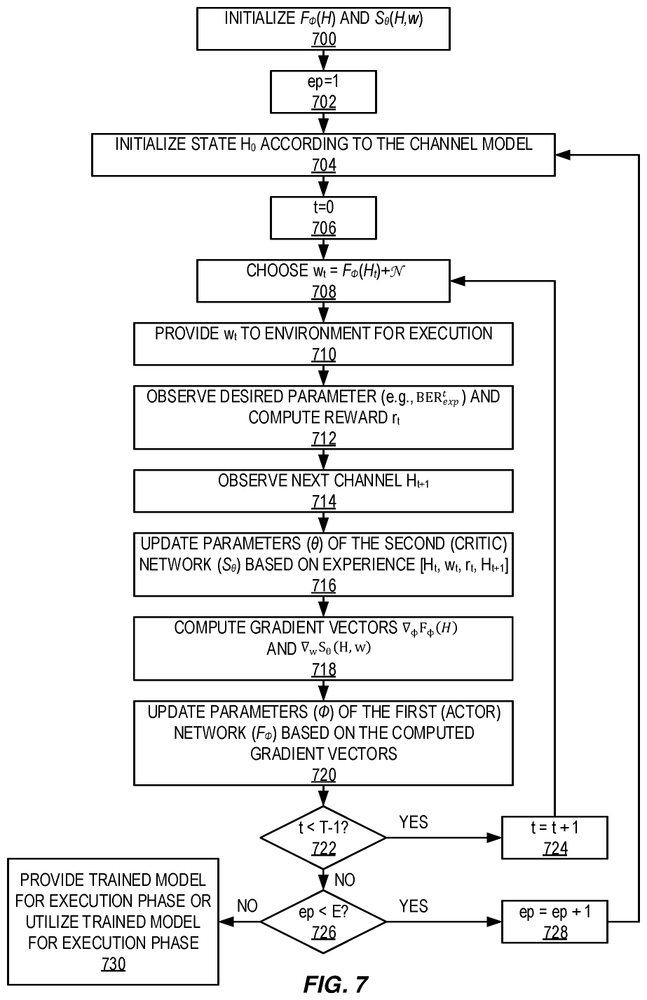

FIG. 6 illustrates the operation of the learning agent 102 for one iteration at time t. FIG. 7 is a flow chart that illustrates the learning agent 102 in more detail in accordance with one embodiment of the present disclosure. In the illustrated example, the training is performed in one or more episodes, which are indexed as ep=1, . . . , E. During each episode, a number of iterations of the training are performed at times t=0, 1, . . . , T−1. More specifically, as illustrated, the learning agent 102 initializes the first neural network F_{φ} and the second neural network S_{θ}(step 700). More specifically, the learning agent 102 initializes the neural network parameters φ of the first neural network F_{φ} and the neural network parameters θ of the second neural network S_{θ} by, e.g., setting these parameters to random values.

The learning agent 102 sets the episode index ep to 1 (step 702), and initializes MIMO channel state for time t=0 (i.e., H₀) (step 704). The MIMO channel state H₀ may be initialized based on a known MIMO channel model for the MIMO system 100 or based on a channel measurement from the MIMO system 100. The learning agent 102 sets a time index t equal to 0 (step 206).

The learning agent 102 chooses a precoder wₜ=F_{φ}(Hₜ)+ [symbol] to be executed by a MIMO transmitter in the MIMO system 100, where, as discussed above, [symbol] is an exploration noise (step 708). As discussed above, in one embodiment, the exploration noise [symbol] is a noise vector sampled from a Gaussian random process. In one embodiment, the exploration noise [symbol] is a random noise in the continuous precoder space. In one embodiment, a variance of the exploration noise [symbol] varies over training episodes. In one embodiment, the variance of the exploration noise [symbol] gets smaller over training episodes. In an alternative embodiment, the learning agent 102 chooses a precoder wₜ= [symbol] (Hₜ), where [symbol] denotes a modified version of F_{φ} in which a random noise is added to the neural network parametersφ of the first neural network F_{φ}. In one embodiment, a variance of the exploration noise [symbol] varies over training episodes. In one embodiment, the variance of the exploration noise [symbol] gets smaller over training episodes.

The learning agent 102 executes the chosen precoder wₜ (i.e., the action) in the MIMO system 100 (step 710). In other words, the learning agent 102 provides the chosen precoder wₜ to the MIMO system 100 for execution (i.e., use) in the MIMO system 100. The learning agent 102 observes the experimental BERₑₓₚ^{t} in the MIMO system 100 for time t and computes the reward rₜ (step 712). In one example, the reward rₜ is computed in accordance with Equation (6). The learning agent 102 observes the next MIMO channel state Hₜ₊₁ in the MIMO system 100 (step 714).

The learning agent 102 updates the neural network parameters θ of the second (critic) neural network S_{θ} via Q-learning on the experience [sₜ, aₜ, rₜ, sₜ₊₁] (step 716). The learning agent 102 also computes the gradient vectors ∇_{φ}F_{φ} and ∇_{w}S_{θ}(step 718) and updates the neural network parameters φ of the first (actor) neural network F_{φ} based on the gradient vectors ∇_{φ}F_{φ} and ∇_{w}S_{θ} in accordance with the parameter update rule of Equation (7) (step 720).

The learning agent 102 determines whether the last iteration for the current training episode has been reached (i.e., whether t<T−1) (step 722). If the last iteration has not been reached (i.e., if t<T−1), the learning agent increments t (step 724) and the process returns to step 708 and is repeated for the next iteration. Once the last iteration for the current training episode has been reached, the learning agent 102 determines whether the last episode has been reached (i.e., determines whether ep<E) (step 226). If not, the learning agent 102 increments the episode index ep (step 228) and the process returns to step 704 and repeated for the next episode. Once the last episode has been reached, the training process ends and an execution phase begins. For the execution phase, the learning agent 102 provides the trained model (e.g., provides the neural network parameters φ of the first neural network F_{φ}) to the MIMO system 100) or utilizes the trained model (e.g., utilizes the first neural network F_{φ} for precoder selection for the MIMO system 100). Thus, in the execution phase, a MIMO transmitter within the MIMO system 100 transmits a signal using the precoder selected by the trained first neural network F.

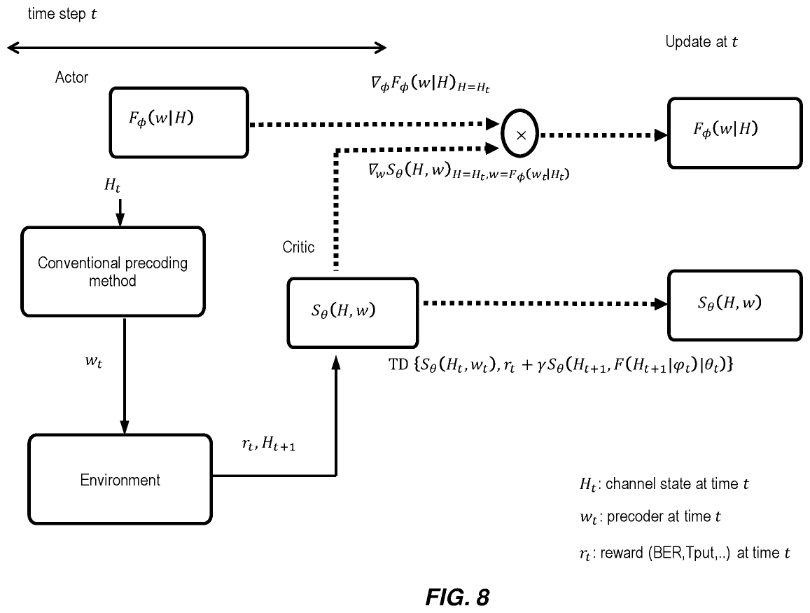

In the embodiments described above, the learning agent 102 chooses the precoder wₜ for each training iteration. However, the present disclosure is not limited thereto. FIG. 8 illustrates another embodiment in which the precoder wₜ for each training iteration is instead chosen in the MIMO system 100 using a conventional precoder selection scheme, where this chosen precoder wₜ is observed by the learning agent 102 and used for training. The conventional precoder selection scheme may, for example, be a Singular Value Decomposition (SVD) based precoder selection scheme, a Zero-forcing (ZF) precoder selection scheme, a regularized ZF (RZF) precoder selection scheme, or a Minimum Mean Square Error (MMSE) based precoder selection scheme.

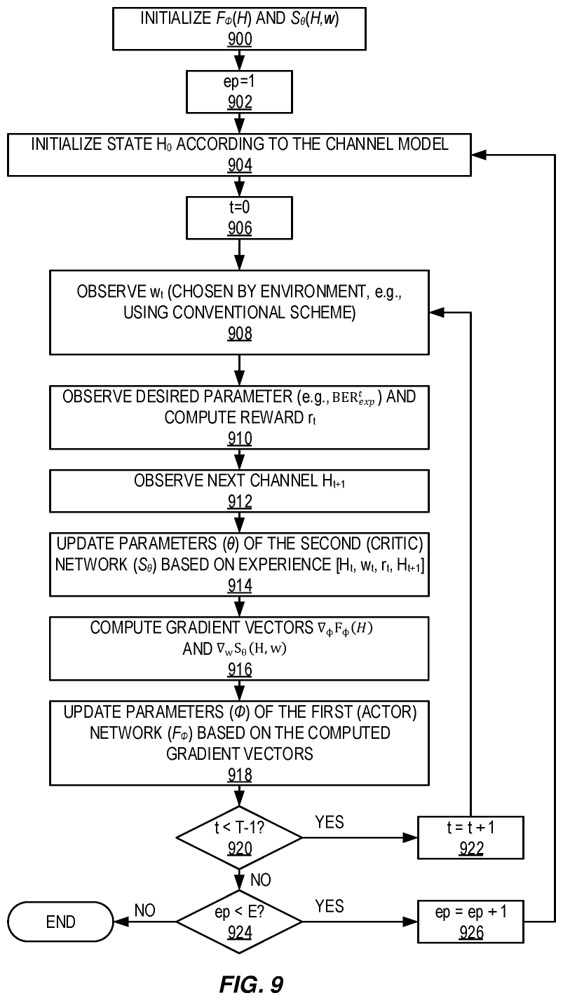

FIG. 9 is a flow chart that illustrates the learning agent 102 in more detail in accordance with the embodiment of FIG. 8. In the illustrated example, the training is performed in one or more episodes, which are indexed as ep=1, . . . , E. During each episode, a number of iterations of the training are performed at times t=0, 1, . . . ,T−1. More specifically, as illustrated, the learning agent 102 initializes the first neural network F_{φ} and the second neural network S_{θ}(step 900). More specifically, the learning agent 102 initializes the neural network parameters φ of the first neural network F_{φ} and the neural network parameters θ of the second neural network S_{θ} by, e.g., setting these parameters to random values.

The learning agent 102 sets the episode index ep to 1 (step 902), and initializes MIMO channel state for time t=0 (i.e., H₀) (step 904). The MIMO channel state H₀ may be initialized based on a known MIMO channel model for the MIMO system 100 or based on a channel measurement from the MIMO system 100. The learning agent 102 sets a time index t equal to 0 (step 906).

The learning agent 102 observes a precoder wₜ executed in the MIMO system 100 (step 908). As discussed above, the precoder wₜ is selected in the MIMO system 100 in accordance with a conventional precoder selection scheme. The learning agent 102 observes the experimental BERₑₓₚ^{t} in the MIMO system 100 for time t and computes the reward rₜ (step 910). In one example, the reward rₜ is computed in accordance with Equation (6). The learning agent 102 observes the next MIMO channel state Hₜ₊₁ in the MIMO system 100 (step 912).

The learning agent 102 updates the neural network parameters θ of the second (critic) neural network S_{θ} via Q-learning on the experience [sₜ, aₜ, rₜ, sₜ₊₁] (step 914). The learning agent 102 also computes the gradient vectors ∇_{φ}F_{φ} and ∇_{w}S_{θ}(step 916) and updates the neural network parameters φ of the first (actor) neural network F_{φ} based on the gradient vectors ∇_{φ}F_{φ} and ∇_{w}S_{θ} in accordance with the parameter update rule of Equation (7) (step 918).

The learning agent 102 determines whether the last iteration for the current training episode has been reached (i.e., whether t<T−1) (step 920). If the last iteration has not been reached (i.e., if t<T−1), the learning agent increments t (step 922) and the process returns to step 908 and is repeated for the next iteration. Once the last iteration for the current training episode has been reached, the learning agent 102 determines whether the last episode has been reached (i.e., determines whether ep<E) (step 924). If not, the learning agent 102 increments the episode index ep (step 926) and the process returns to step 904 and repeated for the next episode. Once the last episode has been reached, the training process ends.

It should be noted that, once the first neural network F_{φ} is trained, the first neural network F_{φ} can be used for selecting the precoder w for the MIMO system 100 during an execution phase. During the execution phase, training of the first and second neural networks may cease or may only be performed occasionally (e.g., periodically).

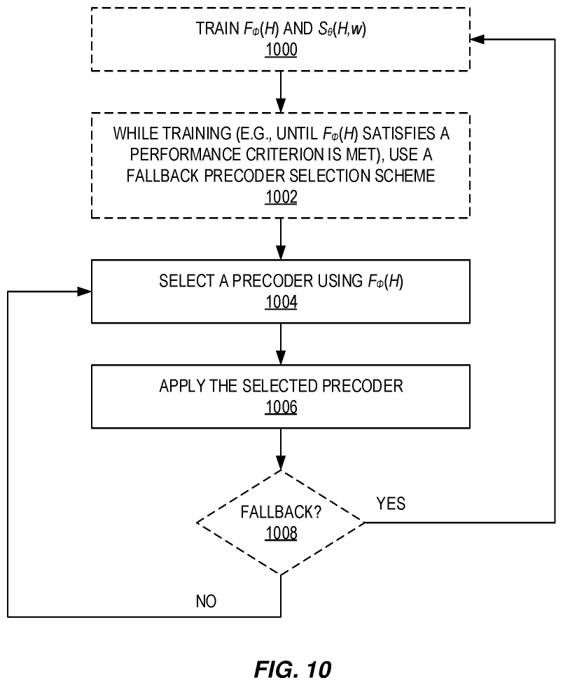

FIG. 10 is a flow chart that illustrates the operation of the learning agent 102 and the MIMO system 100 in accordance with another embodiment of the present disclosure in which the first neural network F_{φ} is used for selecting the precoder w for the MIMO system 100 during an execution phase. Note that optional steps are represented by dashed lines. As illustrated, the learning agent 102 trains the first neural network F_{φ} and the second neural network S_{θ}(H, w), as described above (step 1000). Note that step 1000 is optional in the sense that the first neural network F_{φ} may be trained using some alternative training scheme or may be outside of the scope of the processing node that is performing the method of FIG. 10. While the first neural network F_{φ} is being trained (e.g., until the first neural network F_{φ} satisfies a predefined or preconfigured performance criterion), the MIMO system 100 uses a fallback precoder selection scheme to select the precoder w for the MIMO system 100 (step 1002). The fallback precoder selection scheme may be a conventional precoder selection scheme. The conventional precoder selection scheme may, for example, be a SVD based precoder selection scheme, a ZF precoder selection scheme, a RZF precoder selection scheme, or a MMSE based precoder selection scheme.

Once the first neural network F_{φ} is trained, the learning agent 102 or the MIMO system 100 uses the first neural network F_{φ} to select a precoder w for a MIMO transmitter of the MIMO system 100 (step 1004). The MIMO system 100 then applies the selected precoder w in the MIMO transmitter (step 506).

Optionally, the MIMO system 100 or the learning agent 102 determines whether to fall back to the fallback precoder (e.g., if the performance of the first neural network F_{φ}, falls below a predefined or preconfigured threshold) (step 1008). If so, the process returns to step 1000. Otherwise, the process returns to step 1004.

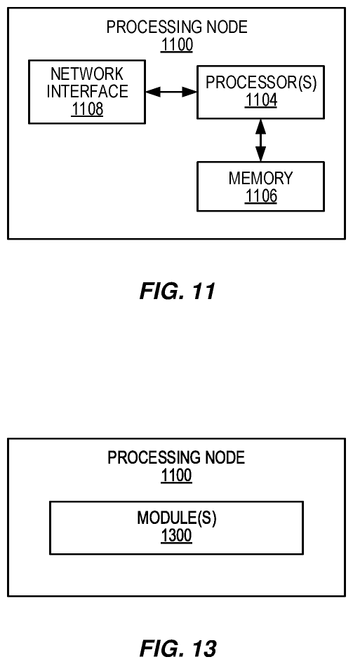

FIG. 11 is a schematic block diagram of a processing node 1100 on which the learning agent 102 may be implemented in accordance with some embodiments of the present disclosure. As illustrated, the processing node 1100 includes one or more processors 1104 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. The one or more processors 1104 operate to provide one or more functions of the learning agent 102 as described herein. In some embodiments, the function(s) are implemented in software that is stored, e.g., in the memory 1106 and executed by the one or more processors 1104.

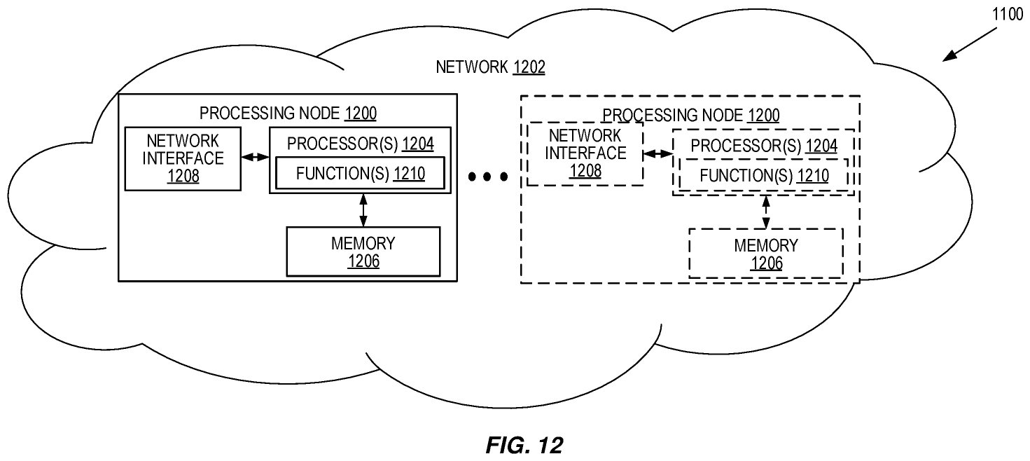

FIG. 12 is a schematic block diagram that illustrates a virtualized embodiment of the processing node 1100 according to some embodiments of the present disclosure. As used herein, a “virtualized” processing node is an implementation of the processing node 1100 in which at least a portion of the functionality of the processing node 1100 is implemented as a virtual component(s) (e.g., via a virtual machine(s) executing on a physical processing node(s) in a network(s)). As illustrated, in this example, the processing node 1100 includes one or more processing nodes 1200 coupled to or included as part of a network(s) 1202. Each processing node 1200 includes one or more processors 1204 (e.g., CPUs, ASICs, FPGAs, and/or the like), memory 1206, and a network interface 1208.

In this example, functions 1210 of the learning agent 102 described herein are implemented at the one or more processing nodes 1200 or distributed across two or more of the processing nodes 1200 in any desired manner. In some particular embodiments, some or all of the functions 1210 of the learning agent 102 described herein are implemented as virtual components executed by one or more virtual machines implemented in a virtual environment(s) hosted by the processing node(s) 1200.

In some embodiments, a computer program including instructions which, when executed by at least one processor, causes the at least one processor to carry out the functionality of the learning agent 102 or a processing node(s) 1100 or 1200 implementing one or more of the functions of the learning agent 102 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the processing node 1100 according to some other embodiments of the present disclosure. The processing node 1100 includes one or more modules 1300, each of which is implemented in software. The module(s) 1300 provide the functionality of the learning agent 102 described herein. This discussion is equally applicable to the processing node(s) 1200 of FIG. 12 where the modules 1300 may be implemented at one of the processing nodes 1200 or distributed across two or more of the processing nodes 1200.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GS Fifth Generation System
ASIC Application Specific Integrated Circuit
CPU Central Processing Unit
DSP Digital Signal Processor
FPGA Field Programmable Gate Array
LTE Long Term Evolution

Those skilled in the art will recognize improvements and modifications to the embodiments of the present disclosure. All such improvements and modifications are considered within the scope of the concepts disclosed herein.

### REFERENCES

[1] R. S. Sutton et al., “Reinforcement Learning: An Introduction,” second edition, MIT Press, Cambridge, Mass., London, 2017.
[2] I. Goodfellow et al., “Deep Learning,” MIT Press, 2016.
[3] V. Mnih et al., “Playing Atari with Deep Reinforcement Learning,” in NeurIPS Deep Learning Workshop, 2013.
[4] V. Mnih et al., “Human-level control through deep reinforcement learning,” Nature, vol. 518, pp. 529-532, February 2015.
[5] T. P. Lillicrap et al., “Continuous control with deep reinforcement learning,” in International Conference on Learning Representations (ICLR), 2016.

1. A computer implemented method performed by an agent for training a first neural network that maps a Multiple Input Multiple Output, MIMO, channel state to a precoder in a continuous precoder space, the method comprising:
initializing first neural network parameters, φ, of a first neural network, F_{φ}(H), that estimates a first precoding policy that maps a channel state, H, for a MIMO system to a precoder, w, in a continuous precoder space;
initializing second neural network parameters, θ, of a second neural network, S_{θ}(H, w), that estimates a value function that maps the channel state, H, for the MIMO system and the precoder, w, in the continuous precoder space to a value, q, of the precoder, w, in the channel state H;
initializing an initial channel state, H₀, for the MIMO system based on a channel model for the MIMO system or a channel measurement in the MIMO system; and
for each time t in a set of times t=0 to t=T−1, where T is a predefined integer value that is greater than 1:
choosing or obtaining a precoder, wₜ, for a channel state, Hₜ, that is to be executed or has been executed by a MIMO transmitter in the MIMO system;
observing a parameter in the MIMO system as a result of execution of the precoder, wₜ;
computing a reward, rₜ, based on the parameter;
observing a channel state, Hₜ₊₁, for time t+1;
updating the second neural network parameters, θ, of the second neural network, S_{θ}(H, w), based on an experience [Hₜ, wₜ, rₜ, Hₜ₊ᵢ];
computing a gradient, ∇_{φ}F_{φ}, which is a gradient of the first neural network, F_{φ}(H), with respect to the first neural network parameters, φ;
computing a gradient, ∇_{w}S_{θ}, which is a gradient of the second neural network, S_{θ}(H, w), with respect to the precoder, w; and
updating the first neural network parameters, φ, of the first neural network, F_{φ}(H), based on the gradient, ∇_{φ}F_{φ}, and the gradient, ∇_{w}S_{θ}.

2. The method of claim 1 further comprising either:
providing the first neural network parameters, φ, of the first neural network, F_{φ}(H), to the MIMO system to be used by the MIMO system for precoder selection; or
utilizing the first neural network, F_{φ}, (H), for precoder selection for the MIMO system during an execution phase.

3. The method of claim 1 wherein updating the first neural network parameters, φ, of the first neural network, F_{φ}(H), based on the gradient, ∇_{φ}F_{φ}, and the gradient, ∇_{w}S_{θ}, comprises updating the first neural network parameters, φ, of the first neural network, F_{φ}, (H), in accordance with a rule:
φ←φ+η∇_{φ},F_{φ},(H)∇_{w}S_{θ}(H,W)|_{H=H}_{ₜ}_{w=F}_{_{φ}}_{(w}_{ₜ}₎
where η is a predefined learning rate.

4. The method of claim 1 wherein updating the second neural network parameters, θ, of the second neural network, S_{θ}(h, w), based on the experience [Hₜ, wₜ, rₜ, Hₜ₊₁] comprises updating the second neural network parameters, θ, of the second neural network, S_{θ}(H, w), based on the experience [Hₜ, wₜ, rₜ, Hₜ₊₁] in accordance with a Q-learning scheme.

5. The method of claim 1 wherein the parameter observed in the MIMO system as a result of execution of the precoder, wₜ, is block error rate.

6. The method of claim 1 wherein the parameter observed in the MIMO system as a result of execution of the precoder, wₜ, is throughput.

7. The method of claim 1 wherein the parameter observed in the MIMO system as a result of execution of the precoder, wₜ, is channel capacity.

8. The method of claim 1 wherein choosing or obtaining the precoder, wₜ, for the channel state, Hₜ, comprises choosing the precoder, wₜ, for the channel state, Hₜ, as:
wₜ=F_{φ},(Hₜ)+ [symbol] ,
where [symbol] is an exploration noise.

9. The method of claim 8 further comprising providing the precoder, wₜ, to the MIMO system for execution by the MIMO transmitter.

10. The method of claim 8 or 9 wherein the exploration noise is a random noise in the continuous precoder space.

11. The method of claim 10 wherein the step of initializing the initial channel state, H₀, and the steps of choosing or obtaining the precoder, wₜ, observing the parameter in the MIMO system, computing the reward, rₜ, observing the channel state, Hₜ₊₁, updating the second neural network parameters, θ, computing the gradient, ∇_{φ}F_{φ}, computing the gradient, ∇_{w}S_{θ}, and updating the first neural network parameters, φ, for each time t in the set of times t=0 to t=T−1 are repeated for two or more episodes, and a variance of the exploration noise varies over the two or more episodes.

12. The method of claim 11 wherein the variance of the exploration noise gets smaller over the two or more episodes.

13. The method of claim 1 wherein choosing or obtaining the precoder, wₜ, for the channel state, Hₜ, comprises choosing the precoder, wₜ, for the channel state, Hₜ, as:
wₜ= [symbol] (Hₜ),
where [symbol] corresponds to the first neural network, F_{φ}(H), but where an exploration noise is added to the first neural network parameters, φ.

14. The method of claim 13 further comprising providing the precoder, wₜ, to the MIMO system for execution by the MIMO transmitter.

15. The method of claim 13 wherein the exploration noise is a random noise in a parameter space of the first neural network, F_{φ}(H).

16. The method of claim 15 wherein the step of initializing the initial channel state, H₀, and the steps of choosing or obtaining the precoder, wₜ, observing the parameter in the MIMO system, computing the reward, rₜ, observing the channel state, Hₜ₊₁, updating the second neural network parameters, θ, computing the gradient, ∇_{φ}F_{φ}, computing the gradient, ∇_{w}S_{θ}, and updating the first neural network parameters, φ, for each time t in the set of times t=0 to t=T−1 are repeated for two or more episodes, and a variance of the exploration noise varies over two or more episodes.

17. The method of claim 16 wherein the variance of the exploration noise gets smaller over the two or more episodes.

18-29. (canceled)

30. A processing node that implements an agent for training a first neural network that maps a Multiple Input Multiple Output, MIMO, channel state to a precoder in a continuous precoder space, the processing node comprising processing circuitry configured to cause the processing node to:
initialize first neural network parameters, φ, of a first neural network, F_{φ}(H), that estimates a first precoding policy that maps a channel state, H, for a MIMO system to a precoder, w, in a continuous precoder space;
initialize second neural network parameters, θ, of a second neural network, S_{θ}(H, w), that estimates a value function that maps the channel state, H, for the MIMO system and the precoder, w, to a value, q, of the precoder, w, in the channel state, H;
initialize an initial channel state, H₀, for the MIMO system based on a channel model for the MIMO system or a channel measurement in the MIMO system; and
for each time t in a set of times t=0 to t=T−1, where T is a predefined integer value that is greater than 1:
choose or obtain a precoder, wₜ, for a channel state, Hₜ, that is to be executed or has been executed by a MIMO transmitter in the MIMO system;
observe a parameter in the MIMO system as a result of execution of the precoder, wₜ;
compute a reward, rₜ, based on the parameter;
observe a channel state, Hₜ₊₁, for time t+1;
update the second neural network parameters, θ, of the second neural network, S_{θ}(H, w), based on an experience [Hₜ, wₜ, rₜ, Hₜ₊₁];
compute a gradient, ∇_{φ}F_{φ}, which is a gradient of the first neural network, F_{φ}(H), with respect to the first neural network parameters, φ;
compute a gradient, ∇_{w}S_{θ}, which is a gradient of the second neural network, S_{θ}(H, w), with respect to the precoder, w; and
update the first neural network parameters, φ, of the first neural network, F_{φ}(H), based on the gradient, V_{φ}F_{φ}, and the gradient, ∇_{w}S_{θ}.

31. A computer implemented method for precoder selection and application for a Multiple Input Multiple Output, MIMO, system comprising:
selecting a precoder, w, for a MIMO transmitter of the MIMO system using a first neural network, F_{φ}(H), that estimates a first precoding policy that maps a channel state, H, for the MIMO system to the precoder, w, in a continuous precoder space; and
applying the selected precoder, w, in the MIMO transmitter.

32. The method of claim 31 wherein the method further comprises training the first neural network, F_{φ}(H), based on a neural network parameter update rule:
φ←φ+η∇_{φ},F_{φ},(H)∇_{w}S_{θ}(H,W)|_{H=H}_{ₜ}_{w=F}_{_{φ}}_{(w}_{ₜ}₎
where:
φ is a first set of neural network parameters of the first neural network, F_{φ}, (H);
η is a predefined learning rate;
∇_{φ}F_{φ}, is a gradient of the first neural network, F_{φ}(H), with respect to the first set of neural network parameters, φ;
∇_{w}S_{θ} is a gradient of a second neural network, S_{θ}(H, w), with respect to the precoder, w, wherein the second neural network, S_{θ}(H, w), estimates a value function that maps the channel state, H, for the MIMO system and the precoder, w, to a value, q, of the precoder, w, in the channel state, H; and
θ is a second set of neural network parameters of the second neural network, S_{θ}(H, w).

33-36. (canceled)
